(19) United States
(12) Patent Application Publication
(10) Pub. No.: US 2008/0163697 A1
(43) Pub. Date: Jul. 10, 2008

(54) Swing speed indicator

(76) Inventors: Ohlan Silpachai, Newbury Park, CA (US); Michael Karst, Newbury Park, CA (US)

Correspondence Address: Ohlan Silpachai, 1343 Mountain VIew Drive, Newbury Park, CA, 91320, US

(21) Appl. No.: 11/649,101

(22) Filed: Jan. 4, 2007

(51) Int. Cl. G01F 1/00

(52) U.S. Cl. 73/861

(57) ABSTRACT

In sports such as tennis, golf, and baseball, generating high racquet, club, or bat speed when striking the ball is important in the game. For a tennis player, a higher racquet speed can result in a bigger serve or a bigger ground stroke. For a golfer, a higher club swing speed can result in longer range drive. And for a batter, a faster swing speed can mean a homerun. Proper swing techniques are crucial in generating high ball speed, but lack of speed feedback for a recreational player makes improvement difficult. Without feedback of the ball speed, it is difficult for a player to know if recent improvements in techniques have resulted in faster ball speed. The present invention provides swing speed feedback for players to help them generating higher ball speeds.

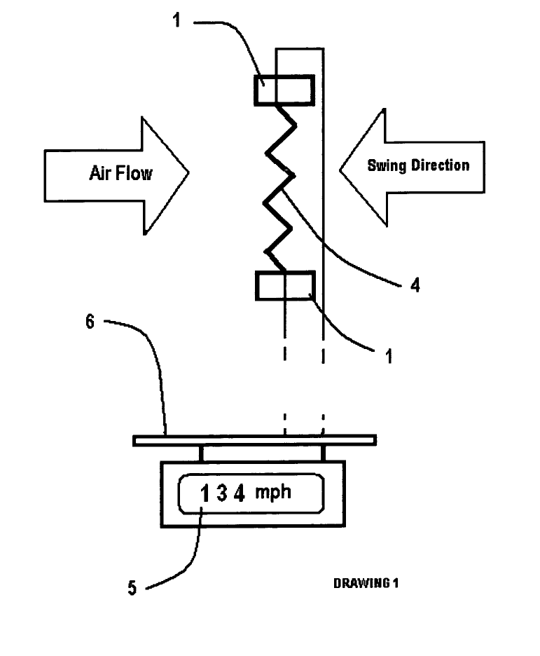

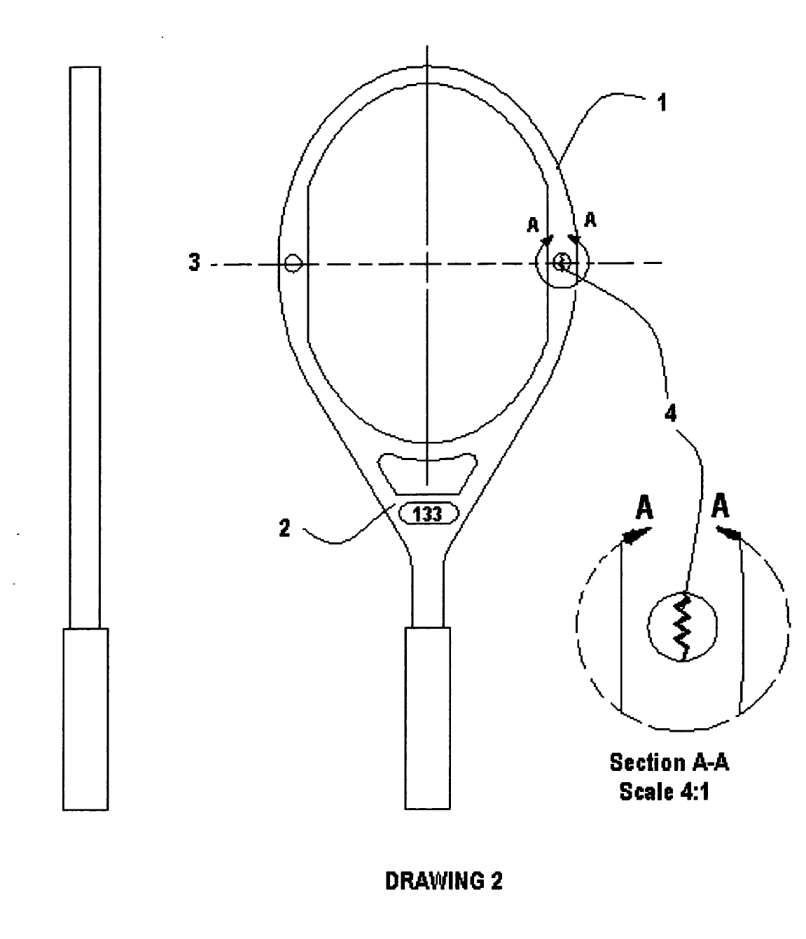

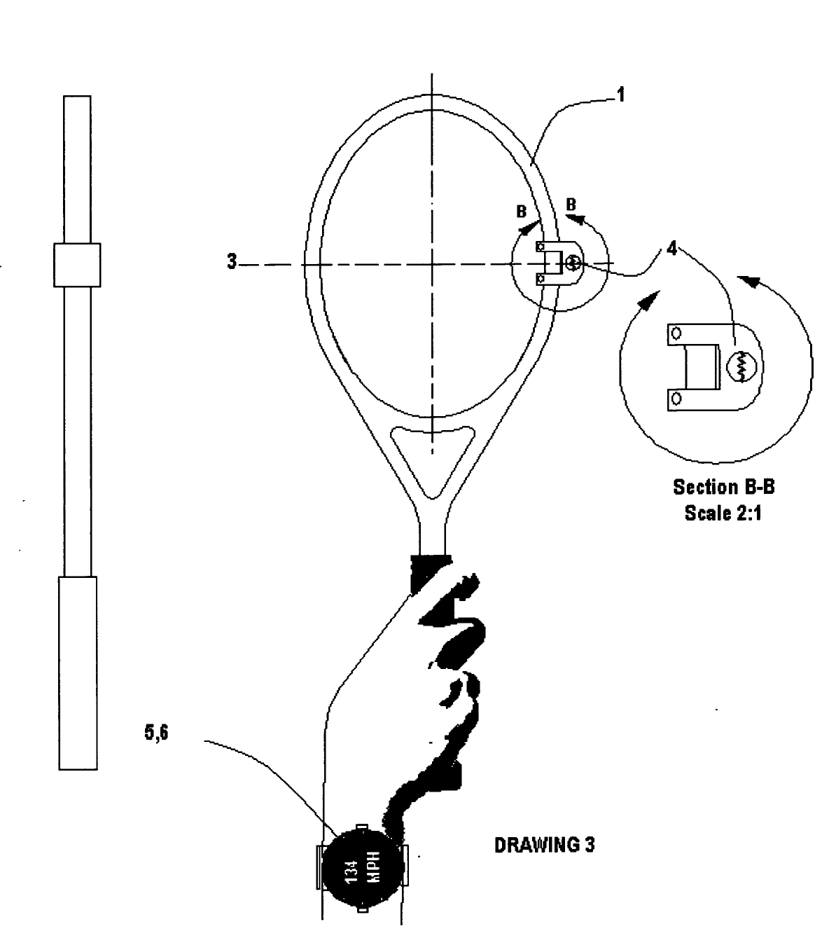

The present invention provides a user with the swing speed by means of measuring speed of the air moving in the opposite direction of the swinging club, racquet, or bat. The invention is intended to be used as a training apparatus for a player to improve swing speed by providing speed feedback.

The present invention employs at least one mass flow meter (U.S. Pat. No. 6,279,394) either embedded or attached to the racquet, club, or bat to measure maximum airspeed generated during a swing. The mass flow meter is a sensor that measures air speed utilizing the thermometric principal. The controller (Unpatented) correlates air flow signals from the mass flow meter to swing speed and shows a relative speed value on a display (Unpatented) integrated or attached to the racquet, club, or bat. The display can also be strapped onto the player's wrist or clipped onto a clothing item. With the present invention, the swing speed is immediately displayed to the user after each stroke thus allowing the user to vary his/her techniques with instant feedback.

The most common method of providing ball speed feedback in the sports arena utilizes laser or radar to directly measure the speed of the ball (U.S. Pat. No. 2,626,986). However, this method is costly for the recreational players. Other methods (U.S. Pat. No. 4,377,125 and U.S. Pat. No. 4,967,596) employ a mechanical system where a mass in a guide (in a bore) is accelerated against a spring during the swing. This mechanical system is complex and moving parts could interfere with the “feel” of the racquet, club, or bat.

### BRIEF DESCRIPTION OF DRAWINGS

DRAWING 1 is a simplified diagram of the invention. DRAWING 2 depicts a view of a mass flow sensor and speed display integrated into a tennis racquet. DRAWING 3 depicts a mass flow sensor that is attached onto a tennis racquet frame while the speed is displayed on a remote screen similar to a wrist watch.

### DETAILED DESCRIPTION OF DRAWINGS

DRAWING 1 illustrates the method on which the invention operates. During a swing, air flows through the mass flow meter 4 that is integrated or attached to a racquet, club, or bat 1. As air flows through the mass flow meter 4 element, the controller 6 measures the air speed through the element and determines the racquet, bat or club swing speed and displays the information to the player on the display 5. In addition to converting the mass flow meter 4 output into swing speed, the controller 6 also stores calibration values and offers user function such as but not limited to; clearing and storing of the air speed.

DRAWING 2 shows one embodiment of a swing speed indicator integrated into a tennis racquet. The mass flow meter 4 is integrated into the tennis racquet frame 1, located along the axis of the strike zone 3 or parallel to the plane that the ball is struck. During a swing, the mass flow meter 4 measures air speed and the controller 6 converts the value to a swing speed. This value is shown on the display 5 screen integrated into the upper portion of the frame handle 2. The apparatus relates the speed of the swinging racquet to the speed of the passing air through the mass flow meter 4. The faster the swing, the faster the air speed measured by the mass flow meter 4. In this embodiment, the display 5 and controller 6 is integrated into the frame handle 2.

DRAWING 3 is another embodiment of the present invention where neither the mass flow meter 4 nor the display 5 are integrated into the tennis racquet. The mass flow meter is attached onto the tennis racquet frame 1 rather than being a part of the racquet. This embodiment offers the user flexibility in moving the invention from one racquet to another. Additionally, the display 5 is not attached to the racquet and is worn on the player's wrist similar to a watch. In this embodiment, the controller 6 may be integrated as part of either the mass flow meter 4 or the display 5. Communication and electrical connection between the mass flow meter 4, controller 6, and display 5 can either be through wires or radio frequency. In this embodiment, the communication between the devices is accomplished through radio frequency method.

Although the present invention has been described in considerable detail with reference to certain preferred configurations thereof, other versions are possible. For example, instead of a numerical value to display speed, the display can provide other means of indicating speed such as a bar graph. Alternatively, swing speed feedback can be accomplished by voice or sound feedback from a speaker.

What is claimed is:

1. An apparatus that provide feedback of the swing speed of a racquet, club, or bat by measuring the air speed comprising:
at least one mass flow meter to measure air speed moving in the opposing direction of the swing;
a controller or electrical circuitry to calibrate and convert the mass flow meter output to swing speed as well as to provide relevant user interface (reset, store, clear display);
at least one display to present the user with swing speed.

2. A method of claim 1, wherein a mass flow meter is used to measure air speed relative to the racquet, bat, or club swing speed.

3. A method of claim 1, wherein a controller or electronic circuit converts the mass flow meter output into swing speed and provides the information to the user on the display.

4. A method of claim 1, wherein a display shows the racquet, bat, or club swing speed to the user via a numerical or graphical means.

5. A system for providing player feedback of the racquet, club, or bat swing speed comprising of; at least one mass air flow meter, an electronic circuit or controller, and a display or speaker to provide swing speed feedback to the player.
